(19) United States
(12) Patent Application Publication
(10) Pub. No.: US 2025/0076591 A1
(43) Pub. Date: Mar. 6, 2025

(54) OPTICAL SEMICONDUCTOR ELEMENT AND METHOD OF MANUFACTURING OPTICAL SEMICONDUCTOR ELEMENT

(71) Applicant: Sumitomo Electric Industries, Ltd., Osaka (JP)

(72) Inventor: Hajime TANAKA, Osaka-shi (JP)

(73) Assignee: Sumitomo Electric Industries, Ltd., Osaka (JP)

(21) Appl. No.: 18/805,963

(22) Filed: Aug. 15, 2024

(30) Foreign Application Priority Data
Sep. 5, 2023 (JP) 2023-143640

(51) Int. Cl. G02B 6/42; G02F 1/29

(52) U.S. Cl. CPC G02B 6/4202; G02F 1/29

(57) ABSTRACT

An optical semiconductor element includes, a substrate having a silicon layer, and a semiconductor element made of a III-V compound semiconductor and bonded to the silicon layer. The silicon layer has a waveguide, a recess, a terrace, and a connecting portion. The recess is a recessed part lower than a surface of the waveguide, a surface of the terrace, and a surface of the connecting portion and is provided between the waveguide and the terrace. The semiconductor element is bonded on the waveguide, the recess, and the connecting portion and has a first tapered portion protruding in a direction in which the waveguide extends. The connecting portion crosses the recess and is connected to the waveguide and the terrace.

### CROSS REFERENCE TO RELATED APPLICATIONS

This application claims priority based on Japanese Patent Application No. 2023-143640 filed on Sep. 5, 2023, and the entire contents of the Japanese patent application are incorporated herein by reference.

### TECHNICAL FIELD

The present disclosure relates to an optical semiconductor element and a method of manufacturing an optical semiconductor element.

### BACKGROUND

A hybrid optical semiconductor element can be formed by bonding a semiconductor element formed of a compound semiconductor and having an optical gain to a substrate such as a silicon on insulator (SOI) substrate (silicon photonics) on which a waveguide is formed (see non-patent literature 1: “Highly efficient double-taper-type coupler between III-V/silicon-on-insulator hybrid device and silicon waveguide” Junichi Suzuki et al. Japanese Journal of Applied Physics 57, 094101 (2018) pp. 94,101-1-094101-6). After the bonding, the semiconductor element is subjected to etching or the like to form a taper.

### SUMMARY

An optical semiconductor element according to the present disclosure includes, a substrate having a silicon layer, and a semiconductor element made of a III-V compound semiconductor and bonded to the silicon layer. The silicon layer has a waveguide, a recess, a terrace, and a connecting portion. The recess is a recessed part lower than a surface of the waveguide, a surface of the terrace, and a surface of the connecting portion and is provided between the waveguide and the terrace. The semiconductor element is bonded on the waveguide, the recess, and the connecting portion and has a first tapered portion protruding in a direction in which the waveguide extends. The connecting portion crosses the recess and is connected to the waveguide and the terrace.

### BRIEF DESCRIPTION OF THE DRAWINGS

FIG. 1 is a perspective view illustrating an optical semiconductor element according to a first embodiment.

FIG. 2A is a plan view illustrating an optical semiconductor element.

FIG. 2B is a plan view illustrating a substrate.

FIG. 3A is a cross-sectional view illustrating an optical semiconductor element.

FIG. 3B is a cross-sectional view illustrating an optical semiconductor element.

FIG. 3C is a cross-sectional view illustrating an optical semiconductor element.

FIG. 4A is a cross-sectional view illustrating an optical semiconductor element.

FIG. 4B is a cross-sectional view illustrating an optical semiconductor element.

FIG. 4C is a cross-sectional view illustrating an optical semiconductor element.

FIG. 5A is a plan view illustrating a method of manufacturing an optical semiconductor element.

FIG. 5B is a plan view illustrating a method of manufacturing an optical semiconductor element.

FIG. 6 is a plan view illustrating an optical semiconductor element according to a comparative example.

FIG. 7A is a cross-sectional view illustrating an optical semiconductor element.

FIG. 7B is a cross-sectional view illustrating an optical semiconductor element.

FIG. 7C is a cross-sectional view illustrating an optical semiconductor element.

FIG. 7D is a cross-sectional view illustrating an optical semiconductor element.

FIG. 8A is a plan view illustrating an optical semiconductor element according to a second embodiment.

FIG. 8B is a plan view illustrating a substrate.

FIG. 9A is a cross-sectional view illustrating an optical semiconductor element.

FIG. 9B is a cross-sectional view illustrating an optical semiconductor element.

FIG. 10A is a plan view illustrating an optical semiconductor element according to a third embodiment.

FIG. 10B is a plan view illustrating a substrate.

FIG. 11A is a cross-sectional view illustrating an optical semiconductor element.

FIG. 11B is a cross-sectional view illustrating an optical semiconductor element.

FIG. 12 is a plan view illustrating an optical semiconductor element according to a fourth embodiment.

FIG. 13A is a cross-sectional view illustrating an optical semiconductor element.

FIG. 13B is a cross-sectional view illustrating an optical semiconductor element.

FIG. 13C is a cross-sectional view illustrating an optical semiconductor element.

FIG. 14A is a cross-sectional view illustrating an optical semiconductor element.

FIG. 14B is a cross-sectional view illustrating an optical semiconductor element.

FIG. 14C is a cross-sectional view illustrating an optical semiconductor element.

FIG. 15A is a cross-sectional view illustrating an optical semiconductor element.

FIG. 15B is a cross-sectional view illustrating an optical semiconductor element.

FIG. 16A is a plan view illustrating an optical semiconductor element according to a fifth embodiment.

FIG. 16B is a plan view illustrating a substrate.

FIG. 17A is a plan view illustrating an optical semiconductor element according to a sixth embodiment.

FIG. 17B is a plan view illustrating a substrate.

FIG. 18A is a cross-sectional view illustrating an optical semiconductor element.

FIG. 18B is a cross-sectional view illustrating an optical semiconductor element.

FIG. 18C is a cross-sectional view illustrating an optical semiconductor element.

FIG. 19A is a cross-sectional view illustrating an optical semiconductor element.

FIG. 19B is a cross-sectional view illustrating an optical semiconductor element.

FIG. 19C is a cross-sectional view illustrating an optical semiconductor element.

FIG. 20A is a cross-sectional view illustrating an optical semiconductor element.

FIG. 20B is a cross-sectional view illustrating an optical semiconductor element.

FIG. 20C is a cross-sectional view illustrating an optical semiconductor element.

### DETAILED DESCRIPTION

A trench is provided in the substrate. Etchants may enter the trench, and the semiconductor element may be etched from the junction interface. The unintended etching may cause damage to the semiconductor element, and the bonding strength may be reduced. Thus, the objective is to provide a semiconductor optical element and a method of manufacturing a semiconductor optical clement that can suppress unintended etching.

### Description of Embodiments of Present Disclosure

First, the contents of embodiments of the present disclosure will be listed and explained.

(1) An optical semiconductor element according to one aspect of the present disclosure includes, a substrate having a silicon layer, and a semiconductor element made of a III-V compound semiconductor and bonded to the silicon layer. The silicon layer has a waveguide, a recess, a terrace, and a connecting portion. The recess is a recessed part lower than a surface of the waveguide, a surface of the terrace, and a surface of the connecting portion and is provided between the waveguide and the terrace. The semiconductor element is bonded on the waveguide, the recess, and the connecting portion and has a first tapered portion protruding in a direction in which the waveguide extends. The connecting portion crosses the recess and is connected to the waveguide and the terrace. Since the connecting portion crosses the recess, the liquid entering the recess is blocked by the connecting portion. Thus, the unintended etching of the semiconductor element from the junction interface surface side can be reduced.
(2) In (1), the connecting portion may have a taper shape. The liquid that has entered the recess is blocked by the connecting portion. Unintended etching of a semiconductor element can be reduced. Since the connecting portion and the semiconductor element have a taper shape, it is possible to reduce the loss of light.
(3) In (1), in the connecting portion, a part connected to the waveguide may have a taper shape, and a part connected to the terrace extends in a direction differing from a direction in which the part having the taper shape extends. The first tapered portion of the semiconductor element may be located above the part having the taper shape in the connecting portion. The liquid that has entered the recess is blocked by the connecting portion. Unintended etching of a semiconductor clement can be reduced. Since the connecting portion and the semiconductor element have a taper shape, it is possible to reduce the loss of light.
(4) In any one of (1) to (3), one surface and another surface of the connecting portion in the direction in which the waveguide extends each may have a taper shape. Since the connecting portion and the semiconductor element have a taper shape, it is possible to reduce the loss of light.
(5) In any one of (1) to (4), the semiconductor element may have a first semiconductor layer, a core layer, and a second semiconductor layer. The first semiconductor layer, the core layer, and the second semiconductor layer may be stacked in order from a position closer to the substrate. The first tapered portion may include the first semiconductor layer, the core layer, and the second semiconductor layer. It is possible to reduce the loss of light.
(6) In any one of (1) to (4), the semiconductor element may have a second tapered portion. The second tapered portion may be located above the waveguide to be opposite to the substrate with respect to the first tapered portion in the direction in which the waveguide extends. I It is possible to reduce the loss of light.
(7) In (6), the semiconductor element may have a first semiconductor layer, a core layer, and a second semiconductor layer. The first semiconductor layer, the core layer, and the second semiconductor layer may be stacked in order from a position closer to the substrate. The first tapered portion may include the first semiconductor layer. The second tapered portion may include the core layer and the second semiconductor layer. It is possible to reduce the loss of light.
(8) In any one of (1) to (4), the semiconductor element may have a third semiconductor layer, a core layer, and a fourth semiconductor layer. The core layer may be provided above the waveguide. The core layer may be provided between the third semiconductor layer and the fourth semiconductor layer. The liquid that has entered the recess is blocked by the connecting portion. Unintended etching of a semiconductor element can be reduced.
(9) A method of manufacturing an optical semiconductor clement includes, bonding a semiconductor element made of a III-V compound semiconductor to a silicon layer of a substrate, and forming a first tapered portion at the semiconductor element by wet-etching the semiconductor clement. The silicon layer has a waveguide, a recess, a terrace, and a connecting portion. The recess is a recessed part lower than a surface of the waveguide, a surface of the terrace, and a surface of the connecting portion and is provided between the waveguide and the terrace. The first tapered portion protrudes in a direction in which the waveguide extends. The connecting portion crosses the recess and is connected to the waveguide and the terrace. Since the connecting portion crosses the recess, the liquid entering the recess is blocked by the connecting portion. Thus, the unintended etching of the semiconductor element from the junction interface surface side can be reduced.

### Details of Embodiments of Present Disclosure

Specific examples of an optical semiconductor element and a method of manufacturing an optical semiconductor element according to embodiments of the present disclosure will be described below with reference to the drawings. It is noted that, the present disclosure is not limited to these examples, but is defined by the scope of the claims, and is intended to include all modifications within the meaning and scope equivalent to the scope of the claims.

### First Embodiment

### Optical Semiconductor Element

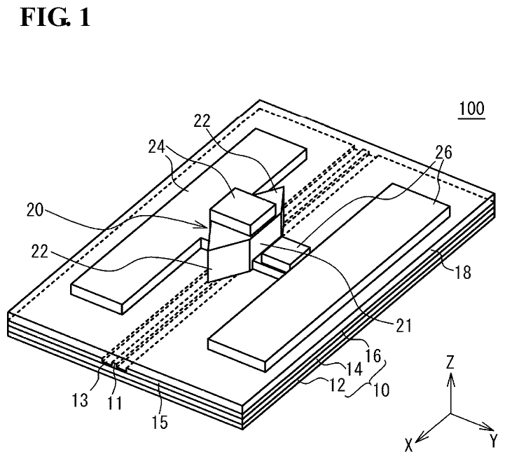

FIG. 1 is a perspective view illustrating an optical semiconductor element 100 according to a first embodiment. As shown in FIG. 1, optical semiconductor element 100 is a hybrid type element having a substrate 10 and a semiconductor element 20. Semiconductor element 20 is an element including a III-V compound semiconductor layer. Semiconductor element 20 is a modulator that changes the refractive index in accordance with a voltage and modulates light. Substrate 10 propagates light. The Z-axis is parallel to a normal line of the upper surface of substrate 10. The X-axis is parallel to the waveguide. The Y-axis is orthogonal to the X-axis and the Z-axis.

Substrate 10 is an SOI substrate including a substrate 12, a box layer 14, and a silicon (Si) layer 16 stacked in order in the Z-axis positive direction. Substrate 12 is formed of, for example, Si. Box layer 14 is formed of, for example, silicon oxide (SiO₂). The thickness of box layer 14 is, for example, 3 μm. Silicon layer 16 is, for example, a 220 nm layer. The upper surface of substrate 10 and the surface of semiconductor element 20 are covered with an insulating film 18. Insulating film 18 is formed of, for example, a 1 μm-thick SiO₂. The refractive index of Si layer 16 is 3.45. The refractive index of box layer 14 and insulating film 18 is 1.45, which is lower than that of Si layer 16.

Si layer 16 of substrate 10 has a waveguide 11, two recesses 13, two terraces 15, and a connecting portion. The connecting portion is not shown in FIG. 1.

Waveguide 11 and recess 13 extend in the same direction and are parallel to the X-axis. Two recesses 13 are trenches located on both sides of waveguide 11. Terrace 15 is a flat surface of Si layer 16 and is positioned opposite to waveguide 11 of recess 13. Recess 13 is recessed from the upper surfaces of waveguide 11 and terrace 15. The bottom surface of recess 13 is Si layer 16, but the bottom surface may be box layer 14. Si layer 16 may be provided with optical components such as a ring resonator and a loop mirror. For example, a ring resonator is formed by bending waveguide 11 into a ring shape.

Semiconductor element 20 is bonded to the upper surface of Si layer 16 of substrate 10, and is located on waveguide 11, recess 13, and terrace 15. Semiconductor element 20 includes a mesa 21 and electrodes 24 and 26. Mesa 21 of semiconductor element 20 is located on waveguide 11. Mesa 21 has a tapered portion 22 (first tapered portion) at a distal end thereof. Tapered portion 22 is protruded from semiconductor element 20 and is tapered along waveguide 11. Insulating film 18 has openings on mesa 21 and on a cladding layer 42.

Electrode 24 extends from the top of mesa 21 to the upper surface of insulating film 18 outside mesa 21. Electrode 24 is formed of a stacked body of titanium (Ti), platinum (Pt), and gold (Au), or the like.

Electrode 26 is spaced apart from electrode 24, is provided on the upper surface of insulating film 18, and is formed of a metal such as an alloy of gold, germanium, and nickel (AuGeNi). Electrodes 24 and 26 may be provided with an Au plating layer or the like. Electrode 24 and electrode 26 are electrically connected to semiconductor element 20 through the opening of insulating film 18.

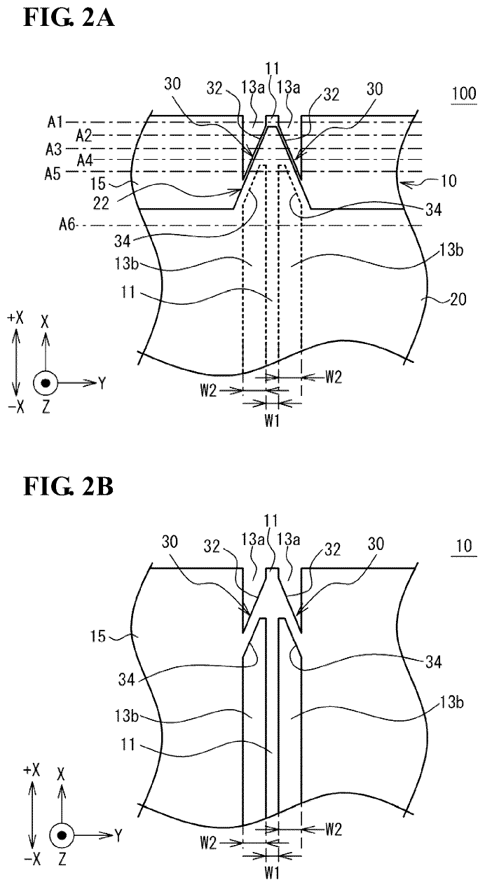

FIG. 2A is a plan view illustrating optical semiconductor element 100, and shows the vicinity of tapered portion 22 of semiconductor element 20. Insulating film 18 is seen through. FIG. 2B is a plan view illustrating substrate 10. FIG. 2A and FIG. 2B show the vicinity of one end of semiconductor clement 20. The opposite end of semiconductor element 20 has the same configuration. As shown in FIG. 2A and FIG. 2B, one direction of the X-axis is defined as a +X direction. The direction opposite to the +X direction is defined as −X direction.

As shown in FIG. 2A, tapered portion 22 of semiconductor element 20 is protruded from the end of semiconductor element 20 in the +X direction. The width of tapered portion 22 increases as the distance from semiconductor element 20 increases, and the width decreases as the distance from semiconductor element 20 increases.

As shown in FIG. 2A and FIG. 2B, Si layer 16 of substrate 10 has a connecting portion 30. One connecting portion 30 is provided in one recess 13. Connecting portion 30 crosses recess 13 and is connected to waveguide 11 and terrace 15. One end of connecting portion 30 is connected to waveguide 11. The other end of connecting portion 30 is connected to terrace 15.

Recesses 13 are located in the +X side and the −X side of connecting portion 30. Recess 13 in the +X side is referred to as a recess 13a. Recess 13 in the −X side is referred to as a recess 13b. Connecting portion 30 blocks recess 13a and recess 13b from each other.

Connecting portion 30 has a taper shape, and extends in the direction in which waveguide 11 extends and is tapered in the direction, similarly to tapered portion 22 of semiconductor element 20. A surface 32 of connecting portion 30 faces in the +X direction. A surface 34 faces the −X direction. Surface 32 has a taper shape along the X-axis direction. A part of surface 34 connected to waveguide 11 is perpendicular to waveguide 11 and parallel to the Y-axis. The part of surface 34 connected to terrace 15 has a taper shape.

Tapered portion 22 of semiconductor element 20 is located on waveguide 11, connecting portion 30, and terrace 15. The tip of tapered portion 22 is located on waveguide 11. A part (base end portion) of tapered portion 22 opposite to the tip is located on terrace 15. A part of tapered portion 22 between the distal end and the proximal end is located on connecting portion 30. Surface 32 of connecting portion 30 is located outside tapered portion 22. In other words, tapered portion 22 is not protruded to the +X side of surface 32 of connecting portion 30, but is positioned in the −X side of surface 32.

A width W1 of waveguide 11 along with the Y-axis shown in FIG. 2A is, for example, 1 μm. Recess 13 has a width W2 of, for example, 4 μm. The thickness of connecting portion 30 is, for example, 0.5 μm and may be 1 μm or less.

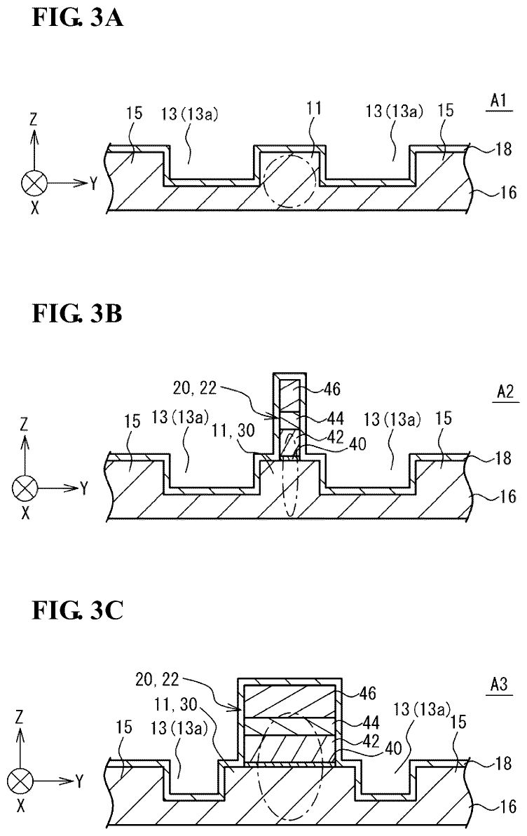

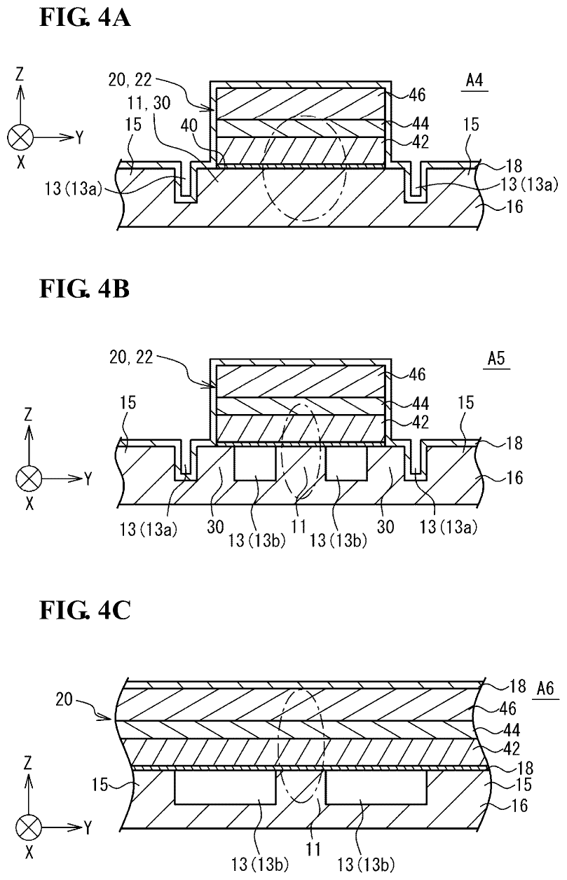

FIG. 3A to FIG. 4C are cross-sectional views illustrating optical semiconductor element 100, showing cross-sectional surfaces along a line A1, a line A2, a line A3, a line A4, a line A5, and a line A6 of FIG. 2A, respectively. In substrate 10, Si layer 16 is shown, and substrate 12 and box layer 14 are omitted. As shown in FIG. 3A to FIG. 4C, the upper surfaces of waveguide 11, terrace 15 and connecting portion 30 are located at the same height. The bottom surface of recess 13 is recessed from the upper surface of waveguide 11.

As shown in FIG. 3A, waveguide 11 is located between two recesses 13a. As shown in FIG. 3B to FIG. 4B, connecting portion 30 extends from waveguide 11 toward terrace 15. Connecting portion 30 approaches terrace 15, and the width of recess 13a becomes smaller. As shown in FIG. 4B, connecting portion 30 is separated from waveguide 11. Recess 13b is located between connecting portion 30 and waveguide 11. Recess 13a is located between connecting portion 30 and terrace 15. Between line A5 and line A6, connecting portion 30 is integrated with terrace 15. Recess 13a disappears. As shown in FIG. 4C, recess 13b is located between terrace 15 and waveguide 11.

As shown in FIG. 3B to FIG. 4C, semiconductor element 20 includes a junction layer 40, cladding layer 42 (these layers are first semiconductor layers), a core layer 44, and a cladding layer 46 (second semiconductor layer). Junction layer 40 is in contact with the upper surface of Si layer 16 of substrate 10 and is bonded to Si layer 16.

Cladding layer 42, core layer 44, and cladding layer 46 are stacked in this order on the upper surface of junction layer 40. Tapered portion 22 is formed of junction layer 40, cladding layer 42, core layer 44, and cladding layer 46.

Semiconductor element 20 has a vertical positive-intrinsic-negative (pin) junction. Junction layer 40 is formed of, for example, indium gallium arsenide phosphide (InGaAsP). Cladding layer 42 is formed of, for example, n-type indium phosphide (n-InP). The total thickness of junction layer 40 and cladding layer 42 is, for example, 0.7 μm. Cladding layer 46 is formed of, for example, p-type indium phosphide (p-InP). The thickness of cladding layer 46 is, for example, 0.7 μm. Cladding layer 42 is electrically connected to electrode 26. Cladding layer 46 is electrically connected to electrode 24.

Core layer 44 has a Multi-Quantum Well (MQW) structure, and includes a plurality of well layers and barrier layers alternately stacked. The well layer and the barrier layer are formed of, for example, non-doped semi-insulating indium gallium arsenide phosphide (InGaAsP). The thickness of core layer 44 is, for example, 0.4 μm. A bandgap wavelength of core layer 44 is 1.2 μm.

Insulating film 18 covers the upper surface and the side surface of terrace 15, the bottom surface of recess 13, the side surface and the upper surface of waveguide 11, and the side surface and the upper surface of semiconductor element 20.

Semiconductor element 20 and substrate 10 are optically coupled by evanescent optical coupling. Light is incident on waveguide 11 of substrate 10. The light propagates through waveguide 11 of substrate 10 and is transmitted to semiconductor element 20. The one dot chain line in FIG. 3A to FIG. 4C represents the distribution of light.

Semiconductor element 20 has tapered portion 22. Surface 32 and surface 34 of connecting portion 30 also have a taper shape. Along the X-axis, the widths of tapered portion 22 and connecting portion 30 gradually increase. The refractive index changes little by little. The light gradually changes its shape and transitions to semiconductor element 20. As shown in FIG. 4A, connecting portion 30 is sandwiched between recesses 13a, and as shown in FIG. 4B, recess 13b is located between connecting portion 30 and waveguide 11. Before the light spreads in the lateral direction, it is again concentrated near waveguide 11. Light is less likely to be emitted in the lateral direction. Multimode excitation is also suppressed. The loss of light can be reduced.

Light is modulated by applying a voltage to electrodes 24 and 26 of semiconductor element 20. The modulated light is transmitted from semiconductor element 20 to waveguide 11 of substrate 10.

### Manufacturing Method

A method of manufacturing optical semiconductor element 100 will be described. For example, dry etching is performed on substrate 10 in a wafer state to form recess 13a and recess 13b in Si layer 16. The parts of Si layer 16 which are covered with the mask (not shown) and are not dry-etched become waveguide 11, terrace 15, and connecting portion 30. That is, substrate 10 is processed as shown in FIG. 2B. After the dry etching, the mask is removed.

The wafer different from substrate 10 includes, for example, InP. The wafer is subjected to, for example, Metal Organic Chemical Vapor Deposition (MOCVD), and junction layer 40, cladding layer 42, core layer 44, and cladding layer 46 are epitaxially grown. The wafer is cut to form semiconductor element 20 including an InP substrate. In this step, semiconductor element 20 is rectangular and does not have mesa 21 or the like.

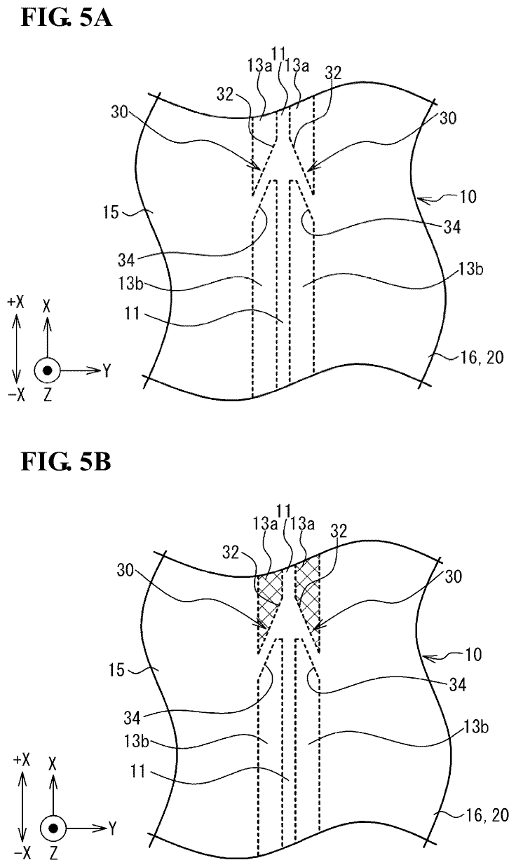

FIG. 5A and FIG. 5B are plan views illustrating a method of manufacturing optical semiconductor element 100. As shown in FIG. 5A, semiconductor element 20 is bonded to Si layer 16 of substrate 10. The upper surface of Si layer 16 and the surface of junction layer 40 of semiconductor element 20 are activated by the plasma irradiation. Junction layer 40 is brought into contact with the upper surface of Si layer 16. For example, annealing is performed at 150° C. to bond semiconductor element 20 to Si layer 16. Semiconductor element 20 is located on waveguide 11, terrace 15, recess 13a, recess 13b, and connecting portion 30.

The InP substrate is removed from semiconductor element 20. Mesa 21 and tapered portion 22 are formed in semiconductor element 20. These steps are performed by wet-etching. For cladding layer 42 and cladding layer 46 of InP, for example, a mixed aqueous solution of hydrochloric acid and phosphoric acid is used as an etchant. For core layer 44 of InGaAsP, for example, sulfuric acid hydrogen peroxide mixture is used as an etchant. A silicon oxide (SiO₂) film is used as an etching mask. Buffered hydrofluoric acid is used to remove the silicon oxide.

The liquid enters recess 13a of Si layer 16 shown by the oblique line in FIG. 5B. Connecting portion 30 of Si layer 16 crosses recess 13 to block the space between recess 13a and recess 13b, and functions as a bank for damming up the liquid. Since connecting portion 30 dams up the liquid, the liquid is kept from entering recess 13b. The etching from the junction interface surface side of semiconductor element 20 is reduced. As shown in FIG. 2A, tapered portion 22 is formed in semiconductor element 20.

After the etching of semiconductor element 20, insulating film 18 is provided. Electrodes 24 and 26 are provided by vacuum deposition or the like. By cutting the wafer, a plurality of optical semiconductor elements 100 are formed from the wafer.

### Comparative Example

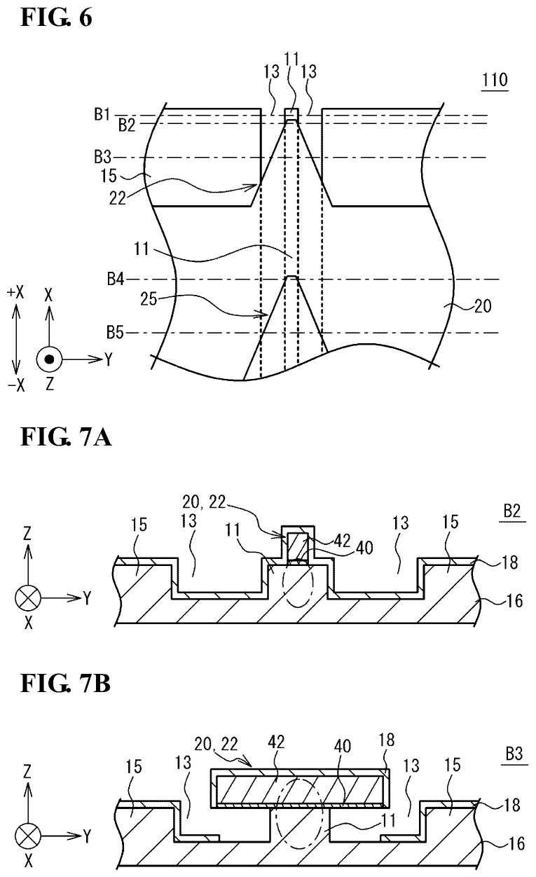

FIG. 6 is a plan view illustrating an optical semiconductor element 110 according to a comparative example. Connecting portion 30 is not provided in Si layer 16. Semiconductor element 20 is located on waveguide 11 and recess 13. Semiconductor element 20 has tapered portion 22 and a tapered portion 25. Tapered portion 22 and tapered portion 25 are located on waveguide 11, recess 13, and terrace 15. Tapered portion 22 is located at the tip of semiconductor element 20. Tapered portion 25 is located inside tapered portion 22, and is located in the −X side in FIG. 6.

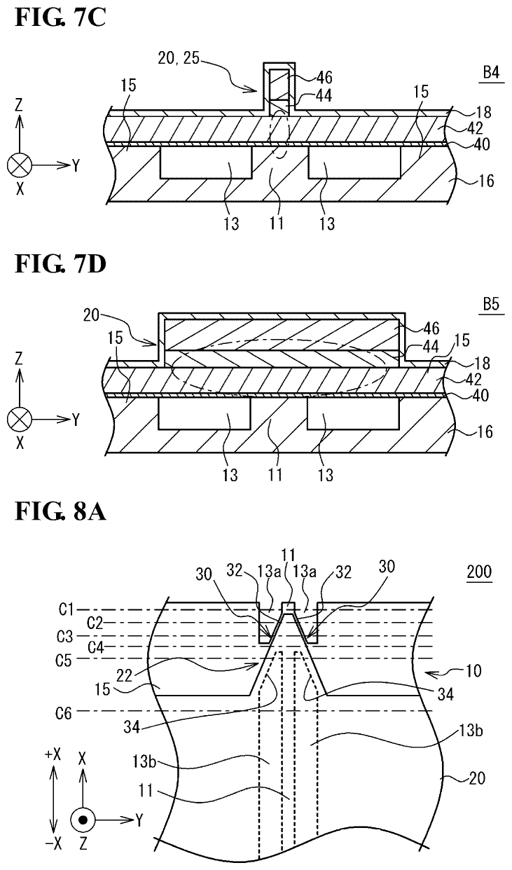

FIG. 7A to FIG. 7D are cross-sectional views illustrating optical semiconductor element 110, showing cross-sectional surfaces along a line B2, a line B3, a line B4, and line a B5 of FIG. 6, respectively. The cross section along a line B1 is the same as in FIG. 3A.

As shown in FIG. 7A to FIG. 7D recess 13 extends from the outside of semiconductor clement 20 under semiconductor element 20. As shown in FIG. 7B and FIG. 7C, tapered portion 22 of semiconductor element 20 is formed of junction layer 40 and cladding layer 42. As shown in FIG. 7C, tapered portion 25 is formed of core layer 44 and cladding layer 46. The light is transmitted from waveguide 11 to semiconductor element 20.

As shown in FIG. 7A to FIG. 7D, semiconductor element 20 is covered with insulating film 18. Insulating film 18 is not easily formed on the lower surface of semiconductor element 20 and on the part of recess 13 that overlaps semiconductor element 20. The surface of semiconductor clement 20 is protected by insulating film 18, but the lower surface of semiconductor element 20 is not easily protected by insulating film 18. In the wet-etching step, the etchant enters recess 13 and flows under semiconductor element 20. Semiconductor clement 20 is etched from the lower surface. Semiconductor element 20 is damaged, and semiconductor element 20 is easily peeled off from substrate 10.

According to the first embodiment, silicon layer 16 of substrate 10 includes waveguide 11, recess 13, terrace 15, and connecting portion 30. As shown in FIG. 2A and FIG. 2B, connecting portion 30 is provided between waveguide 11 and terrace 15, and crosses recess 13. Semiconductor element 20 is bonded to silicon layer 16. In order to form tapered portion 22 in semiconductor element 20, wet-etching is performed. The liquid such as the etchant is blocked by connecting portion 30, and thus is less likely to enter recess 13b in the −X side than connecting portion 30. Thus, the unintended etching of semiconductor element 20 from the junction interface can be reduced. Semiconductor element 20 is less likely to be damaged, and peeling can be reduced.

In the manufacturing step, a liquid such as a hydrochloric acid-based etchant, buffered hydrofluoric acid, or sulfuric acid hydrogen peroxide mixture is used. The liquid is blocked by connecting portion 30, and is kept from entering recess 13b. The unintended etching of semiconductor element 20 can be reduced. Other liquids may be used depending on the material of semiconductor element 20. Liquids are also used in the washing step. These liquids can be dammed up in connecting portion 30.

Connecting portion 30 has a taper shape from a position connected to waveguide 11 to a position connected to terrace 15. Along the direction in which waveguide 11 extends, connecting portion 30 approaches terrace 15 from waveguide 11. The light propagating through waveguide 11 gradually changes its shape and transitions to semiconductor element 20. Light is less likely to be emitted in the lateral direction. Multimode excitation is suppressed. It is possible to reduce the loss of light.

Surface 32 and surface 34 of connecting portion 30 have taper shapes. Waveguide 11 extends from connecting portion 30 in the +X direction and the −X direction. The light is distributed in waveguide 11, spreads laterally in connecting portion 30, and is again concentrated in the center. Since the light changes adiabatically, the loss can be reduced.

Semiconductor element 20 has tapered portion 22. Tapered portion 22 includes junction layer 40, cladding layer 42, core layer 44, and cladding layer 46. The light gradually changes its shape at the tapered shape connecting portion 30 and tapered portion 22 of semiconductor element 20, and then transmitted to semiconductor element 20. It is possible to reduce the loss of light. As will be described later, semiconductor element 20 may have tapered portion 22 and tapered portion 25.

### Second Embodiment

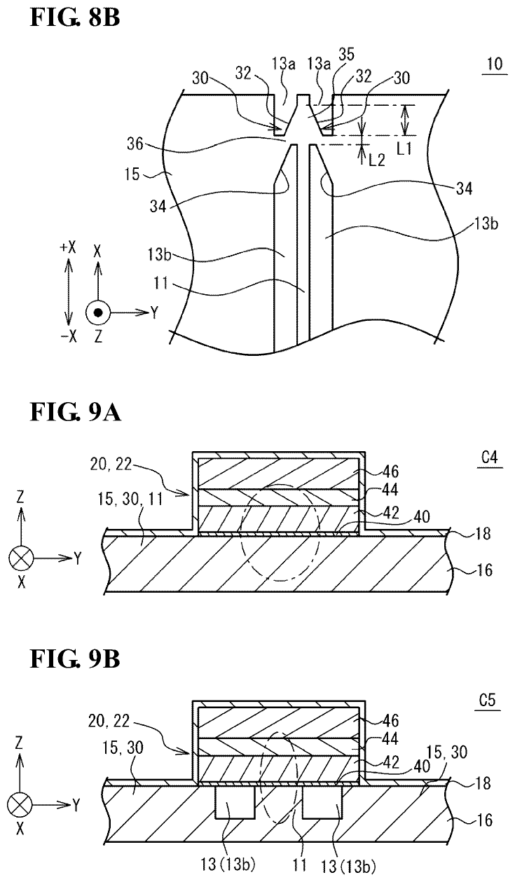

FIG. 8A is a plan view illustrating an optical semiconductor element 200 according to a second embodiment. FIG. 8B is a plan view illustrating substrate 10. The description of the same configuration as that of the first embodiment will be omitted.

Substrate 10 has connecting portion 30. A part of connecting portion 30 has a taper shape. As shown in FIG. 8B, a part 35 of connecting portion 30 is located at the tip of connecting portion 30, has a taper shape, and is connected to waveguide 11. A length L1 of part 35 is, for example, 20 μm or more. A part 36 of connecting portion 30 is located in the −X side of part 35. Part 36 extends in a direction different from that of part 35. Part 36 is, for example, perpendicular to waveguide 11 and parallel to the Y-axis direction. A length L2 of part 36 is smaller than the length L1, and is, for example, 3 μm or less. Surface 32 has a taper shape along part 35 and extends perpendicularly to waveguide 11 along part 36. Surface 34 has a taper shape.

FIG. 9A and FIG. 9B are cross-sectional views illustrating optical semiconductor element 200, showing cross-sectional surfaces of a line C4 position and a line C5 position, respectively. The cross-sectional view along a line C1 is the same as in FIG. 3A. The cross-sectional view along a line C2 is the same as in FIG. 3B. The cross-sectional view along a line C3 is the same as in FIG. 3C. The cross-sectional view along line C6 is the same as in FIG. 4C.

As shown in FIG. 9A, recess 13 is not present at the position of line C4. Waveguide 11, terrace 15 and connecting portion 30 are integrated. As shown in FIG. 9B, at the position of line C5, recess 13b is located between waveguide 11 and connecting portion 30.

According to the second embodiment, the liquid such as the etchant is blocked by connecting portion 30 and is less likely to enter recess 13b in the −X side than connecting portion 30. Thus, the unintended etching of semiconductor element 20 from the junction interface can be reduced.

The light is transmitted from waveguide 11 to semiconductor element 20. Tapered portion 22 of semiconductor element 20 is located on part 35 and on part 36. The light propagating through waveguide 11 is transmitted to semiconductor element 20 in part 35. Since part 35 has a taper shape, the loss of light is reduced. Part 36 of connecting portion 30 is connected to waveguide 11 and terrace 15.

Since the length L2 of part 36 is, for example, 3 μm, the spread of light is reduced and the light is concentrated in the vicinity of waveguide 11. The emission of light in the lateral direction is reduced, and the multimode is also hardly excited. It is possible to reduce the loss of light. When part 36 is long, light is emitted in the lateral direction. When part 36 is too short, the etchant may leak from part 36 and enter recess 13b. The length L2 of part 36 is, for example, 3 μm, which is 10 μm or less. The second embodiment can reduce the radiation of light and also the entry of etchants.

Surface 32 and surface 34 of connecting portion 30 have a taper shape. Since the light changes adiabatically, the loss can be reduced.

### Third Embodiment

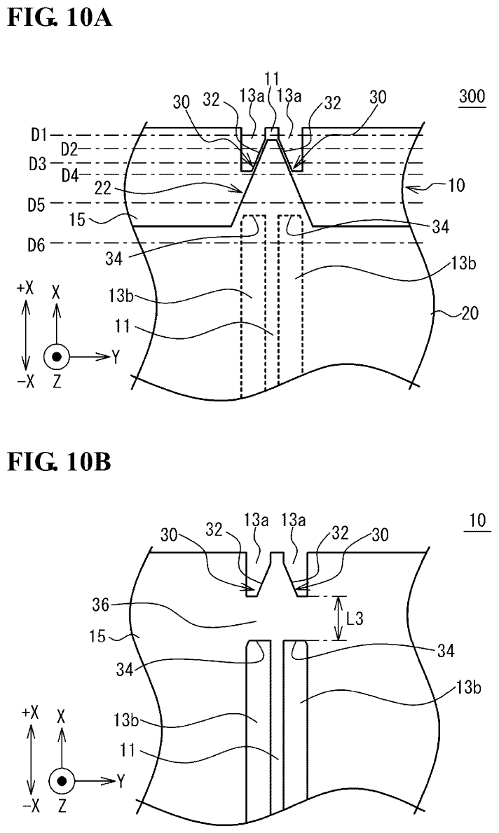

FIG. 10A is a plan view illustrating an optical semiconductor element 300 according to a third embodiment. FIG. 10B is a plan view illustrating substrate 10. The description of the same configuration as that of the first embodiment or the second embodiment will be omitted. As shown in FIG. 10B, part 36 of connecting portion 30 in the third embodiment is longer than that in the second embodiment. A length L3 of part 36 is larger than the length L2 in FIG. 8B, for example, 20 μm. The other configurations are the same as those of the second embodiment.

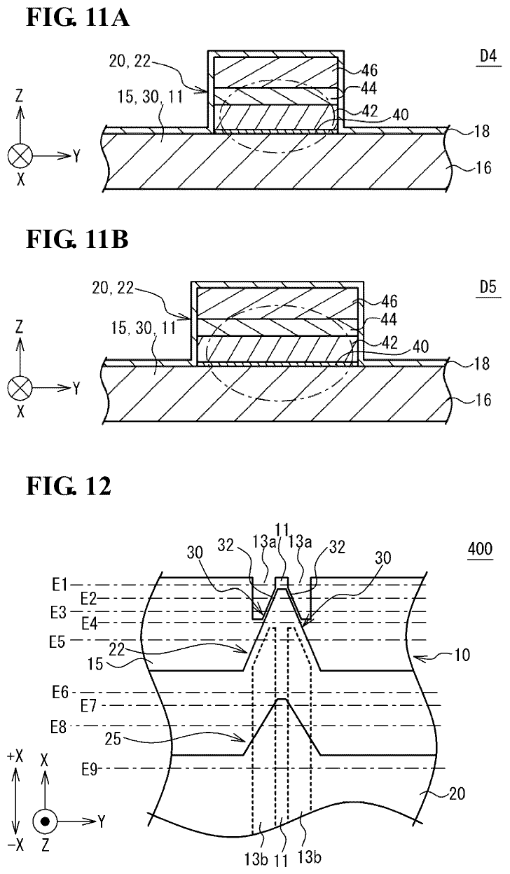

FIG. 11A and 11B are cross-sectional views illustrating optical semiconductor element 300, showing cross-sectional surfaces along a line D4 and a line D5 of FIG. 10A, respectively. The cross-sectional view along a line D1 is the same as in FIG. 3A. The cross-sectional view along a line D2 is the same as in FIG. 3B. The cross-sectional view along a line D3 is the same as in FIG. 3C. The cross-sectional view along a line D6 is the same as in FIG. 4C. As shown in FIG. 11A and FIG. 11B, at the positions of line D4 and line D5, waveguide 11, terrace 15 and connecting portion 30 are integrated.

According to the third embodiment, connecting portion 30 dams up the etchant, and thus the etchant is less likely to enter recess 13b. The unintended etching of semiconductor element 20 can be reduced.

The light is transmitted from waveguide 11 to semiconductor element 20. Part 36 of connecting portion 30 is long. Thus, the light propagating through waveguide 11 spreads laterally when reaching part 36. Between line D5 and line D6, the shape of Si layer 16 changes from part 36 to waveguide 11. Light is emitted because of the rapid change in refractive index. The loss of light is large compared to the second embodiment.

### Fourth Embodiment

FIG. 12 is a plan view illustrating an optical semiconductor element 400 according to a fourth embodiment. Semiconductor element 20 includes first tapered portion 22 and tapered portion 25 (second tapered portion). The other configurations are the same as those of the second embodiment.

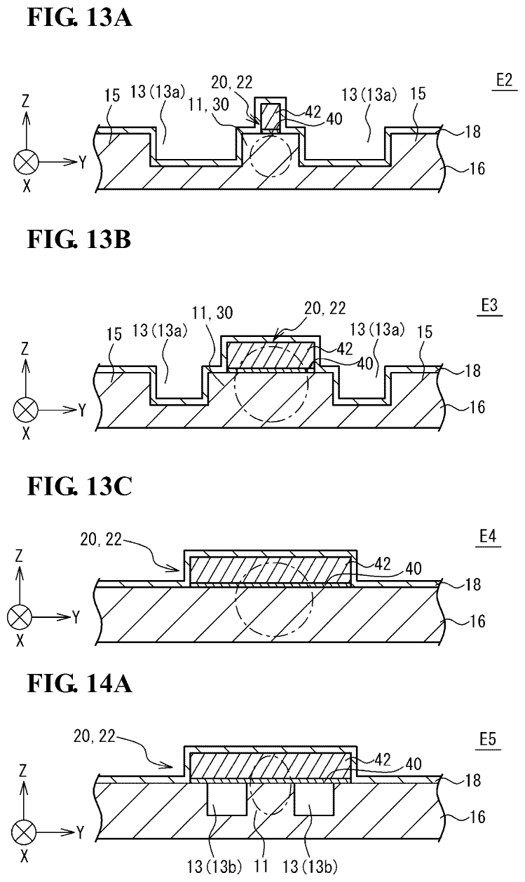

FIG. 13A to FIG. 15B are cross-sectional views illustrating optical semiconductor element 400, showing cross-sectional surfaces along a line E2 to a line E9 of FIG. 12. The cross-sectional view along a line El is the same as in FIG. 3A.

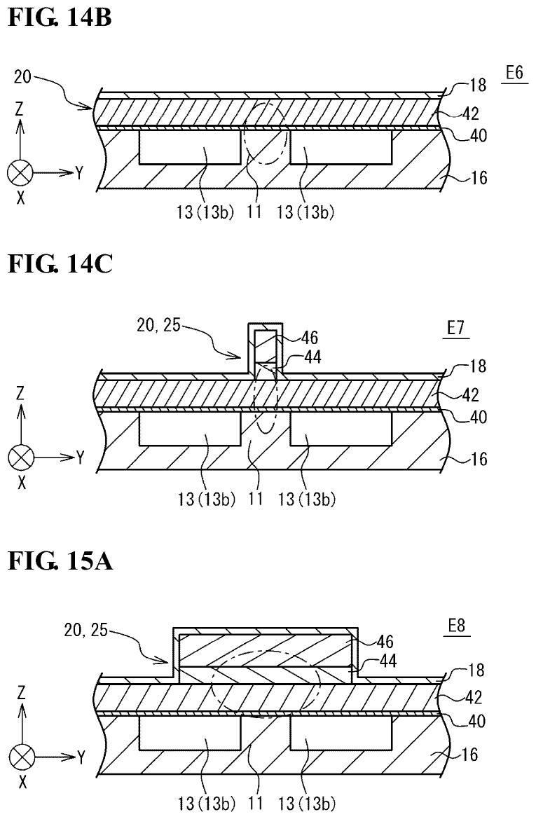

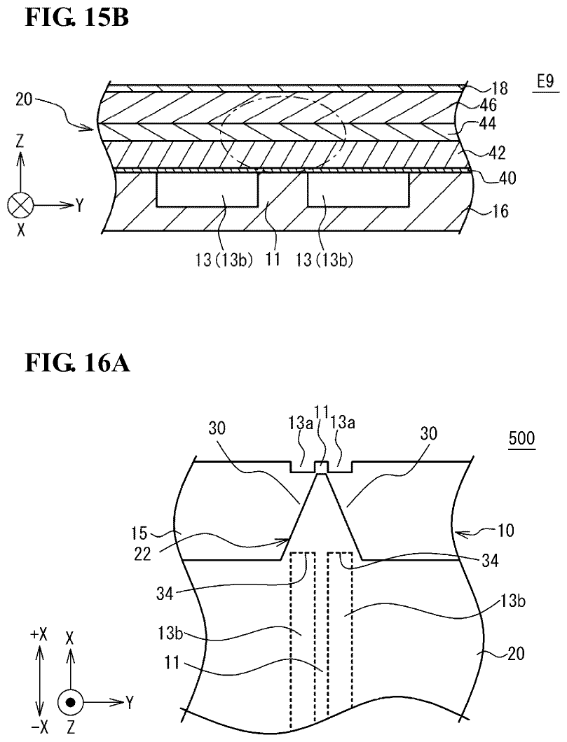

As shown in FIG. 13A to FIG. 14A, tapered portion 22 includes junction layer 40 and cladding layer 42, but does not include core layer 44 and cladding layer 46. As shown in FIG. 14B, junction layer 40 and cladding layer 42 are provided between tapered portion 22 and tapered portion 25 of semiconductor element 20. As shown in FIG. 14C and FIG. 15A, tapered portion 25 is located on the upper surface of cladding layer 42 and includes core layer 44 and cladding layer 46. As shown in FIG. 15B, junction layer 40, cladding layer 42, core layer 44, and cladding layer 46 are provided in the −X side of tapered portion 25. Tapered portion 25 is located opposite to the substrate 10 with respect to tapered portion 22 in the X-axis.

According to the fourth embodiment, the liquid such as the etchant is blocked by connecting portion 30, and is less likely to enter recess 13b in the −X side of connecting portion 30. Thus, the unintended etching of semiconductor element 20 from the junction interface surface can be reduced.

Part 35 of connecting portion 30 connected to waveguide 11 has a taper shape. Semiconductor element 20 has tapered portion 22 and tapered portion 25. Tapered portion 22 is located on part 35 and on part 36. Tapered portion 25 is located in the −X side of tapered portion 22 and is located on waveguide 11. The light propagates through waveguide 11 and transmits to tapered portion 22 of semiconductor element 20. The light distributed in the center is further transmitted to semiconductor element 20 in tapered portion 25. Since semiconductor element 20 has two tapered portions, it is possible to reduce the loss of light.

Tapered portion 22 includes junction layer 40 and cladding layer 42. Tapered portion 25 is disposed on the upper surface of cladding layer 42 and includes core layer 44 and cladding layer 46. The light propagating through waveguide 11 is transmitted to semiconductor element 20 in tapered portion 22. The light is concentrated at the center in the −X side of connecting portion 30. In tapered portion 25, the light is further transmitted to semiconductor element 20. The light can be transmitted from waveguide 11 to semiconductor element 20 while suppressing the loss.

### Fifth Embodiment

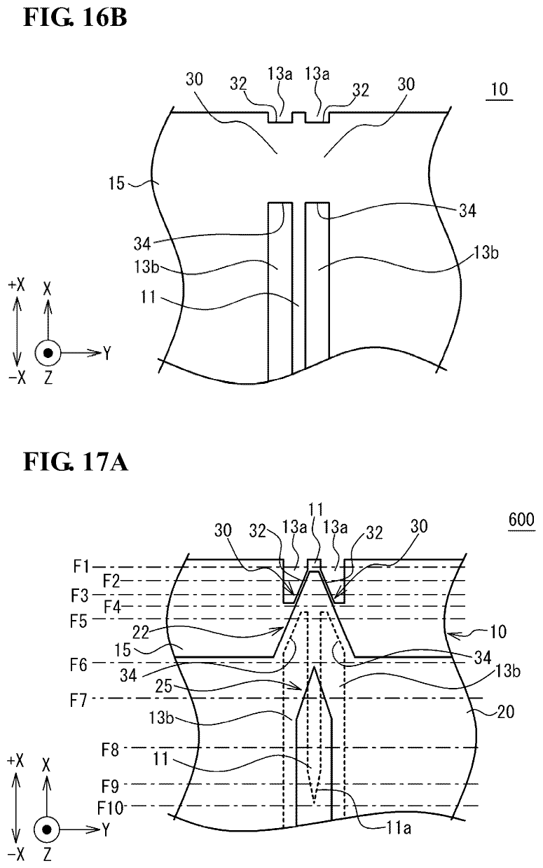

FIG. 16A is a plan view illustrating an optical semiconductor element 500 according to a fifth embodiment. FIG. 16B is a plan view illustrating substrate 10. The description of the same configuration as that of any one of the first embodiment to the fourth embodiment will be omitted. As shown in FIG. 16A and FIG. 16B, connecting portion 30 does not have a taper shape and is parallel to the Y-axis. The other configurations are the same as those of the first embodiment.

According to the fifth embodiment, the liquid such as the etchant is blocked by connecting portion 30, and thus is less likely to enter recess 13b in the −X side of connecting portion 30. Thus, the unintended etching of semiconductor element 20 from the junction interface surface can be reduced. As shown in FIG. 16B, connecting portion 30 is not tapered but extends in the Y-axis. Thus, light is easily emitted in the lateral direction.

### Sixth Embodiment

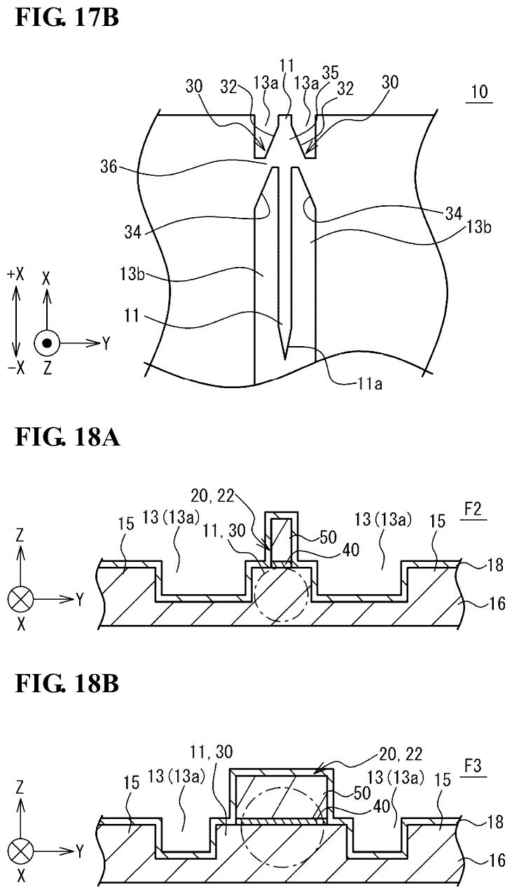

FIG. 17A is a plan view illustrating an optical semiconductor element 600 according to a sixth embodiment. FIG. 17B is a plan view illustrating substrate 10. The description of the same configuration as that of any of the first embodiment to the fifth embodiment will be omitted.

Connecting portion 30 has the same configuration as the example of FIG. 8A and FIG. 8B. Waveguide 11 has a tapered portion 11a. Tapered portion 11a is located under semiconductor element 20 and is tapered in the −X direction. Tapered portion 11a is a tip of waveguide 11 extending in the −X direction. That is, waveguide 11 is cut off at tapered portion 11a, and one recess 13b is positioned in the −X side of tapered portion 11a.

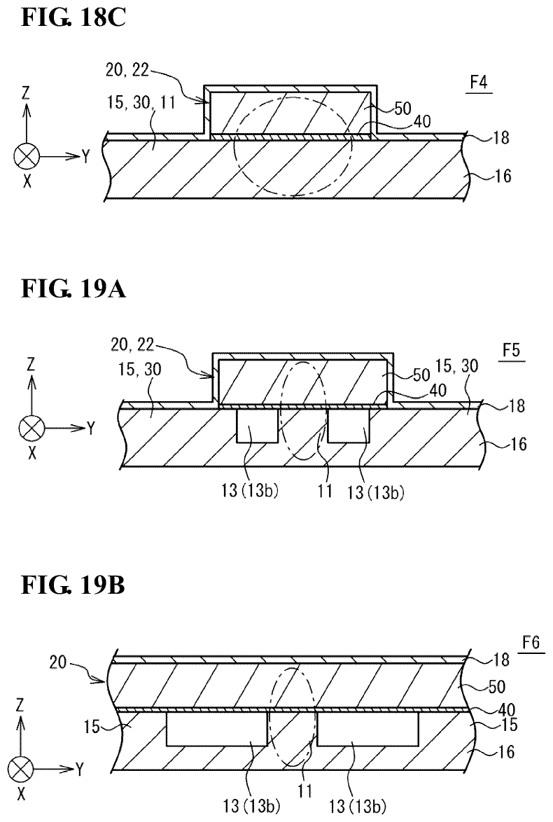

FIG. 18A to FIG. 20C are cross-sectional views illustrating optical semiconductor element 600, showing cross-sectional surfaces along a line F2 to a line F10 of FIG. 17A, respectively. The cross section along a line F1 is the same as in FIG. 3A.

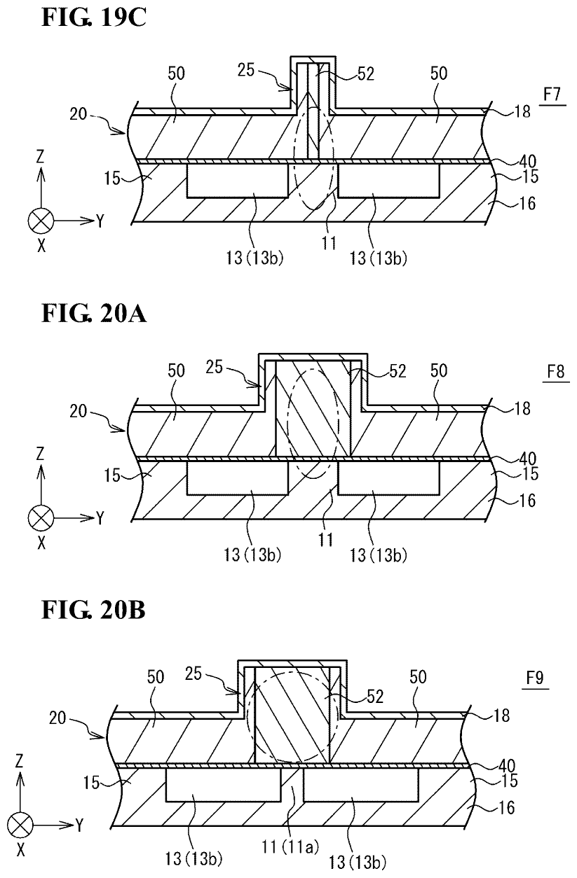

As shown in FIG. 18A to FIG. 19A, semiconductor element 20 has a lateral negative-intrinsic-negative (nin) junction. Semiconductor element 20 includes junction layer 40, a cladding layer 50, and a core layer 52. Cladding layer 50 is formed of, for example, n-type indium gallium arsenide phosphide (n-InGaAsP), and is located on junction layer 40. Core layer 52 is formed of, for example, semi-insulating InGaAsP.

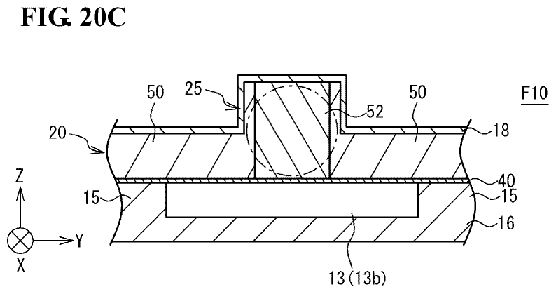

As shown in FIG. 18A to 18C, tapered portion 22 of semiconductor element 20 is formed of cladding layer 50 and is located on waveguide 11 and connecting portion 30. As shown in FIG. 19B, cladding layer 50 is provided between tapered portion 22 and tapered portion 25. As shown in FIG. 19C, tapered portion 25 is formed of cladding layer 50 and core layer 52. The part of cladding layer 50 that is close to waveguide 11 is thicker than the other parts and is divided into two parts in the Y-axis (a third semiconductor layer and a fourth semiconductor layer). Core layer 52 is provided between two cladding layers 50. Tapered portion 25 is located on waveguide 11. As shown in FIG. 20A to FIG. 20C, waveguide 11 is tapered and disappears along the −X direction. Recess 13b is located under tapered portion 25.

According to the sixth embodiment, the liquid such as the etchant is blocked by connecting portion 30, and thus is less likely to enter recess 13b in the −X side of connecting portion 30. Thus, the unintended etching of semiconductor element 20 from the junction interface surface can be reduced.

As shown in FIG. 17A, tapered portion 25 is located on waveguide 11 and recess 13b, but not on terrace 15. That is, tapered portion 25 may be narrowed to about 400 μm. The light can be concentrated in the center. At line F10 position, waveguide 11 can be eliminated. The positions of electrode 24 and electrode 26 in FIG. 1 can be made closer to semiconductor element 20 in the Y direction. Optical semiconductor element 600 can be miniaturized.

As in the first to fifth embodiments, semiconductor element 20 may be a vertical element including semiconductor layers stacked in the vertical direction (Z-axis). As in the sixth embodiment, semiconductor element 20 may be a horizontal element including semiconductor layers stacked in the horizontal direction (Y-axis).

Although the embodiments of the present disclosure have been described in detail, the present disclosure is not limited to the specific embodiments, and various modifications and changes can be made within the scope of the gist of the present disclosure described in the claims.

What is claimed is:

1. An optical semiconductor element comprising:
a substrate having a silicon layer; and
a semiconductor element made of a III-V compound semiconductor and bonded to the silicon layer,
wherein the silicon layer has a waveguide, a recess, a terrace, and a connecting portion,
wherein the recess is a recessed part lower than a surface of the waveguide, a surface of the terrace, and a surface of the connecting portion and is provided between the waveguide and the terrace,
wherein the semiconductor element is bonded on the waveguide, the recess, and the connecting portion and has a first tapered portion protruding in a direction in which the waveguide extends, and
wherein the connecting portion crosses the recess and is connected to the waveguide and the terrace.

2. The optical semiconductor element according to claim 1,
wherein the connecting portion has a taper shape.

3. The optical semiconductor element according to claim 1,
wherein, in the connecting portion, a part connected to the waveguide has a taper shape, and a part connected to the terrace extends in a direction differing from a direction in which the part having the taper shape extends, and
wherein the first tapered portion of the semiconductor element is located above the part having the taper shape in the connecting portion.

4. The optical semiconductor element according to claim 1,
wherein one surface and another surface of the connecting portion in the direction in which the waveguide extends each have a taper shape.

5. The optical semiconductor element according to claim 1,
wherein the semiconductor element has a first semiconductor layer, a core layer, and a second semiconductor layer,
wherein the first semiconductor layer, the core layer, and the second semiconductor layer are stacked in order from a position closer to the substrate, and
wherein the first tapered portion includes the first semiconductor layer, the core layer, and the second semiconductor layer.

6. The optical semiconductor element according to claim 1,
wherein the semiconductor element has a second tapered portion, and
wherein the second tapered portion is located above the waveguide to be opposite to the substrate with respect to the first tapered portion in the direction in which the waveguide extends.

7. The optical semiconductor element according to claim 6,
wherein the semiconductor element has a first semiconductor layer, a core layer, and a second semiconductor layer,
wherein the first semiconductor layer, the core layer, and the second semiconductor layer are stacked in order from a position closer to the substrate,
wherein the first tapered portion includes the first semiconductor layer, and
wherein the second tapered portion includes the core layer and the second semiconductor layer.

8. The optical semiconductor element according to claim 1,
wherein the semiconductor element has a third semiconductor layer, a core layer, and a fourth semiconductor layer,
wherein the core layer is provided above the waveguide, and
wherein the core layer is provided between the third semiconductor layer and the fourth semiconductor layer.

9. A method of manufacturing an optical semiconductor element, the method comprising:
bonding a semiconductor element made of a III-V compound semiconductor to a silicon layer of a substrate; and
forming a first tapered portion at the semiconductor element by wet-etching the semiconductor element,
wherein the silicon layer has a waveguide, a recess, a terrace, and a connecting portion,
wherein the recess is a recessed part lower than a surface of the waveguide, a surface of the terrace, and a surface of the connecting portion and is provided between the waveguide and the terrace,
wherein the first tapered portion protrudes in a direction in which the waveguide extends, and
wherein the connecting portion crosses the recess and is connected to the waveguide and the terrace.
